(19) United States
(12) Patent Application Publication
(10) Pub. No.: US 2017/0174491 A1
(43) Pub. Date: Jun. 22, 2017

(54) Integrated Bottle Opener for Sports and Other Equipment

(71) Applicant: Austin Robert Thomas FONTAINE, Belle River (CA)

(72) Inventor: Austin Robert Thomas FONTAINE, Belle River (CA)

(21) Appl. No.: 14/972,787

(22) Filed: Dec. 17, 2015

(51) Int. Cl. B67B 7/16; A63B 60/16

(52) U.S. Cl. CPC B67B 7/16; A63B 60/16; A63B 2225/00

(57) ABSTRACT

A bottle opener which is integrated with the handle of a hockey stick or other piece of sports or other equipment such as a curling broom, lacrosse stick, or shovel. The opener may be in the form of a plug which is insertable into the hollow end of a hockey stick handle, or in the form of a cap which may be placed over the tip of a hockey stick handle, or in the form of a hinged element which may be rotated horizontally or vertically clear of the hockey stick handle for use in removing a bottle cap from a beverage bottle.

### FIELD OF THE INVENTION

The present invention relates to sports equipment and bar tools. In particular, the present invention relates to bottle openers for use engaging in sports activities.

### BACKGROUND OF THE INVENTION

It is widely known in the prior art to provide various devices which permit the easy, quick, and safe removal of bottle caps from bottles. As shown in the prior art depicted in FIG. 1, most such prior art bottle openers comprise a planar element manufactured of metal or other relatively inflexible material having an opening forming a loop near one end, with a tab projecting into the opening. The opposing end of the planar element may be formed into a hand grip for ease of use.

The length of the opening measured parallel to the projecting tab is slightly more than the diameter of a standard metal bottle cap such as is used on bottled beer, cider, soft drinks and other beverages. The distance from the innermost edge of the tab to the opposite edge of the opening is less than the bottle cap diameter. By placing either the tab or the opposing side of the loop under one edge of a bottle cap on a bottle, the opener may be used as a lever to exert sufficient force on the bottle cap to remove it from the bottle.

For participants in hockey or other sporting activities, it is common to enjoy a bottled beverage before, during, or after activity. It is not always convenient, however, to carry a prior art bottle opener which playing sports. A standard bottle opener is easily misplaced or dropped, which is annoying but may also be a hazard in the case of ice hockey, or may need to be retrieved from a vehicle, locker or gear bag. Particularly in the case of hockey, which requires the use of specialized equipment and bladed skates, it may not be practical to seek out a bottle opener.

It is desirable, therefore, to provide a bottle opener which is easily accessible to a user while engaging in ice hockey or other sports, and which does not interfere with the normal operation of the equipment used for hockey or such other sport.

The device of the present invention addresses the shortcomings in the prior art by providing an improved bottle opener which may be integrated with a hockey stick or other sports equipment.

### BRIEF DESCRIPTION OF THE DRAWINGS

A detailed description of the preferred embodiments is provided by way of example only and with reference to the following drawings, in which:

FIG. 1 is a top plan view of a prior art bottle opener;

FIG. 2A is an upper perspective view of a plug-style hockey stick bottle opener, according to one embodiment of the present invention;

FIG. 2B is a lower perspective view of a plug-style hockey stick bottle opener, according to one embodiment of the present invention;

FIG. 2C is a cutaway view of the plug-style hockey stick bottle opener shown in FIG. 2A;

FIG. 3A is an upper perspective view of a cap-style hockey stick bottle opener, according to one embodiment of the present invention;

FIG. 3B is a lower perspective view of a cap-style hockey stick bottle opener, according to one embodiment of the present invention;

FIG. 3C is a cutaway view of the cap-style hockey stick bottle opener shown in FIG. 3A;

FIG. 4A is a side plan view of a hinge-style hockey stick bottle opener according to the present invention;

FIG. 4B is a top plan view of a hinge-style bottle opener having a horizontal pivot; and

FIG. 4C is a side plan view of a hinge-style bottle opener having a vertical pivot, with the opener in the open position ready for removal of a bottle cap from a sealed beverage bottle.

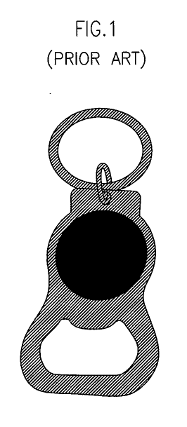

In the drawings, several embodiments of the invention are illustrated by way of example. It is to be expressly understood that the description and drawings are only for the purpose of illustration and as an aid to understanding, and are not intended as a definition of the limits of the invention.

### SUMMARY OF THE INVENTION

In a first embodiment, there is provided a bottle opener for a piece of equipment, the bottle opener comprising a hollow cylinder having openings at top and bottom ends, wherein the inner dimensions and shape of the cylinder are selected to permit the cylinder to snugly fit over the end of the handle of the piece of sports equipment; and first and second opposing tabs projecting into the top end opening from a central position on opposing sides of the opening.

In an alternate embodiment, the bottle opener may have an opening at its top end and an enclosed bottom end, wherein the inner dimensions and shape of the cylinder are selected to permit the cylinder to snugly fit into the end of a hollow handle of the piece of sports equipment, a lip projecting outwardly from the periphery of the top end of the cylinder; and first and second opposing tabs projecting into the top end opening from a central position on opposing sides of the opening.

The piece of equipment may be a hockey stick, a lacrosse stick, a field hockey stick, or a curling broom. Alternatively, the piece of equipment may be a shovel, rake, hoe, weeder, shears, hammer or broom.

In a further embodiment, the bottle opener may comprise a flat loop having horizontal cross-sectional dimensions less than the horizontal cross-sectional dimensions of the top end of the handle of the piece of sports equipment, the opening in the loop having a length greater than the diameter of a bottle cap; means for pivotal attachment of one side of the flat loop to the top end of the handle of the piece of sports equipment; and a tab projecting into the opening from a central position on the opposing side of the flat loop. The means for pivotal attachment may be a vertical hinge pin for horizontal rotation clear of the top of the handle, or a hinge for axial rotation of the loop clear of the top of the handle.

The bottle opener may have means for retaining the flat loop adjacent the top of the handle. The means for retaining the loop atop the handle may be a magnet disposed within the top end of the handle, a resilient spring which in an unstressed state returns the flat loop to a closed position atop the handle, or a resistant hinge pin which retains the flat loop in the rotational position to which it is pivoted.

### DETAILED DESCRIPTION OF THE INVENTION

There is provided an integral bottle opener for a hockey stick or other piece of sports or work equipment having an elongated handle.

In this specification, the terms ‘cylinder’, cylindrical’ and similar are defined to include cylinders of any cross sectional shape, including circular, square, oblong, and rectangular cylinders.

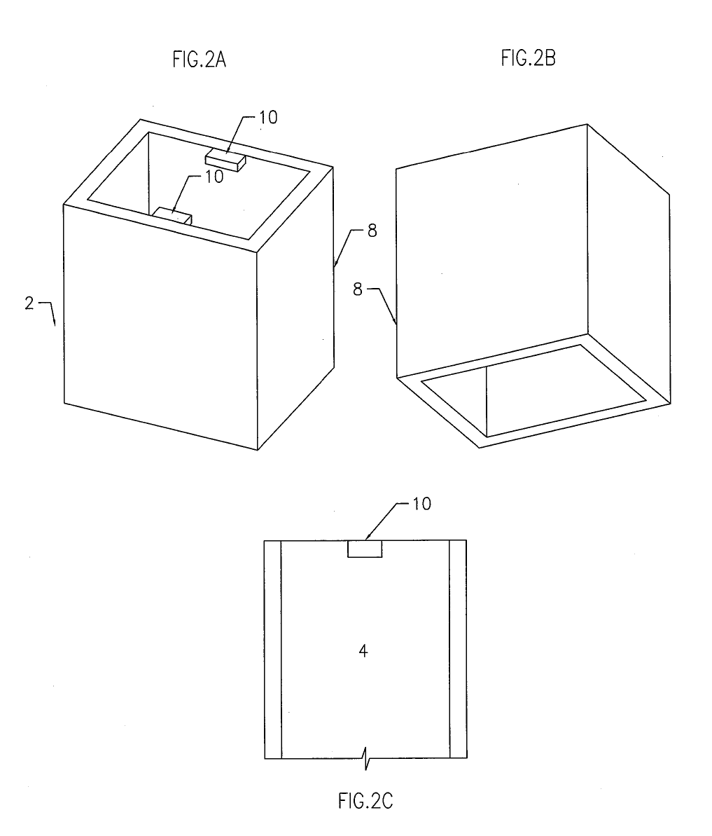

In the case of a hockey stick, the handle may be solid or hollow. According to one preferred embodiment of the present invention for use with a solid handle, as depicted in FIGS. 2A and 2B, the bottle opener may be in the form of a hollow cylindrical cap 2 which is reversibly attachable over the top end of a solid-handled hockey stick 4. This embodiment would function over a hollow-handled hockey stick 6 as well. At the top end of the bottle opener, there is an opening 8 having dimensions selected to allow entry of approximately one half of the bottle cap on a sealed bottle. At a central position on opposing edges of the opening, there is provided a pair of opposing inwardly projecting tabs 10. In the preferred embodiments, the tabs are rectangular, and create an H-shaped opening for the bottle opener. The presence of two opposing tabs permits use of the bottle opener equally well with both the left hand and the right hand. Alternatively, an opening having only a single tab is also within the scope of the invention.

The inner dimensions of the cylindrical cap bottle opener are selected to permit a snug fit over a standard hockey stick handle. Various shapes and dimensions of the cap are possible to permit use of the opener with a wide variety of sports or work equipment handles.

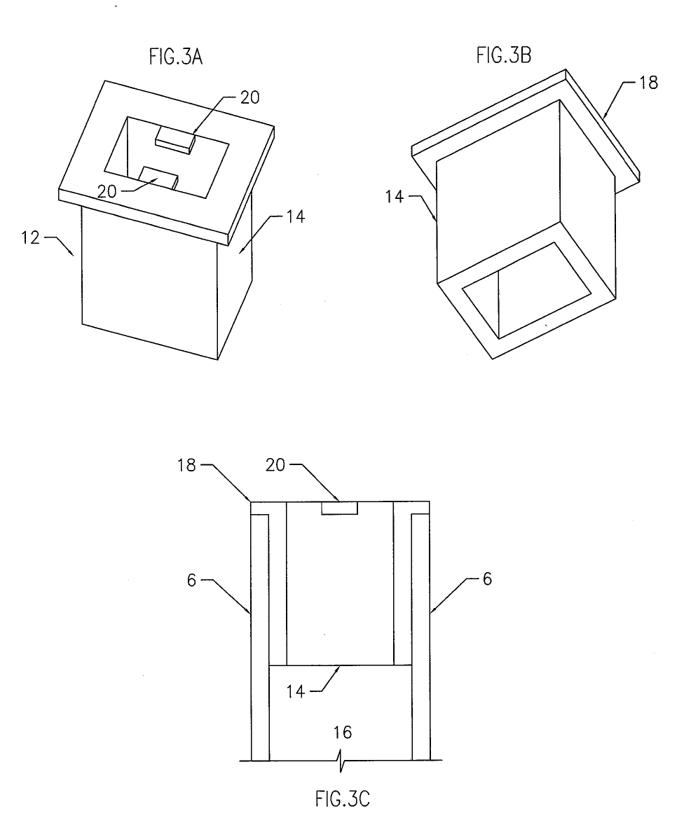

According to another preferred embodiment of the invention as shown in FIGS. 3A and 3B, for use with a hollow handle, the bottle opener may be in the form of a hollow plug 12, having a closed bottom 14, which is reversibly insertable into the hollow top end 16 of the hockey stick. The plug-style bottle opener has a lip 18 projecting outwardly from the upper end to provide a surface against which the upper end of the hockey stick handle may be buttressed. At the top end of the bottle opener, there is an opening having dimensions selected to allow entry of approximately one half of the bottle cap on a sealed bottle. At a central position on opposing edges of the opening, there is provided a pair of opposing inwardly projecting tabs 20. In the preferred embodiments, the tabs are rectangular, and create an H-shaped opening for the bottle opener. Alternatively, an opening having only a single tab is also within the scope of the invention.

The outer dimensions of the lower cylindrical end of the plug-style bottle opener are selected to permit a snug fit inside the hollow top end of a standard hockey stick handle. Various shapes and dimensions of the plug-style opener are possible to permit use of the opener with a wide variety of sports or work equipment having hollow-ended handles.

As well as hockey sticks, the bottle opener of the present invention may be adapted for use with other sports equipment such as lacrosse sticks, golf clubs, field hockey sticks and curling brooms, as well as with work tools such as shovels, rakes, hoes, weeders, trimmers, hammers and brooms.

Preferably, the bottle opener will be manufactured of metal with a plastic laminated coating. Other materials which are sufficiently hard to withstand the force required to remove a bottle cap from a sealed bottle may also be used. Other protective treatments for allowing the bottle opener to withstand the impacts, temperature variations, solar exposure and other environmental conditions are also possible.

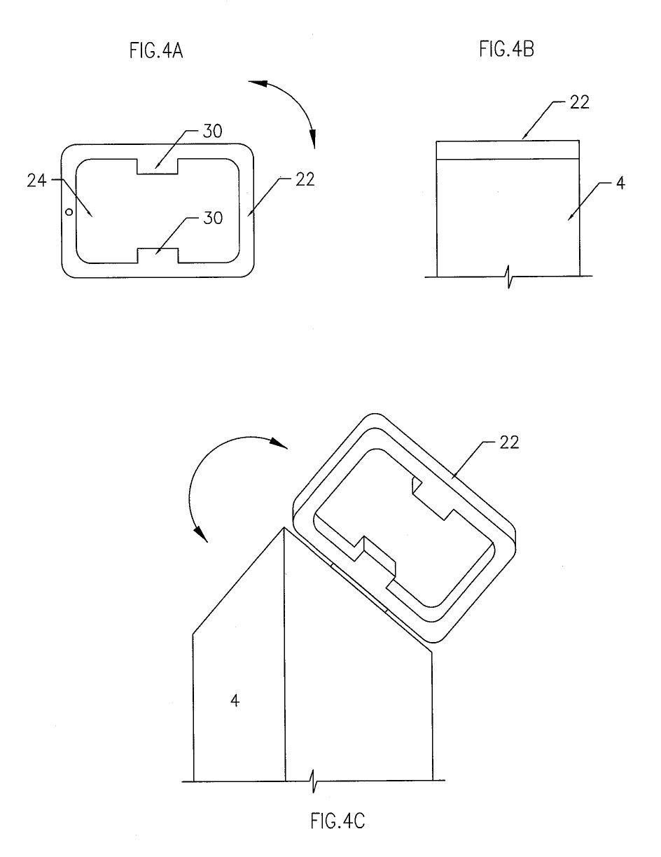

According to yet another embodiment of the invention, as seen in FIGS. 4A, 4B, and 4C, the bottle opener may be a flat loop 22 pivotally attached to the top of a piece of sports or work equipment. The outer perimeter of the flat loop may be any shape corresponding to the top of the handle of the sports or work equipment, including circular, square, oblong, or rectangular. The loop has an opening 24 having dimensions selected to allow entry of approximately one half of the bottle cap on a sealed bottle. The external perimeter of the loop is selected to permit the loop to fit within the cross-sectional area of the top of the hockey stick handle. At a central position on opposing edges of the opening, there is provided a pair of opposing inwardly projecting tabs 30. In the preferred embodiments, the tabs are rectangular, and create an H-shaped opening for the bottle opener. Alternatively, an opening having only a single tab is also within the scope of the invention.

The pivoting hinge-style bottle opener may be hinged to allow horizontal rotation of the loop clear of the top of the handle as depicted in FIG. 4A, or it may be hinged to allow axial rotation about one edge to allow the loop to rotate approximately 180 degrees to clear the top of the handle, as shown in FIG. 4C. Preferably, when not in use, the loop will be retained atop the handle. Several means for retaining the loop atop the handle are possible, including a magnetic element within the top of the handle to engage the metal loop, a spring which is under low or no tension when the axially pivoting loop is in closed position, and resistant hinge pins which only pivot in response to user opening or closing force. By allowing the loop to be rotated horizontally or axially clear of the top of the handle, it is possible to open a bottle with the hockey stick in a substantially vertical position.

It will be appreciated by those skilled in the art that other variations of the preferred embodiment may also be practiced without departing from the scope of the invention.

1. A bottle opener for a piece of equipment, the bottle opener comprising:
a. a hollow cylinder having openings at top and bottom ends, wherein the inner dimensions and shape of the cylinder are selected to permit the cylinder to snugly fit over the end of the handle of the piece of sports equipment; and
b. first and second opposing tabs projecting into the top end opening from a central position on opposing sides of the opening.

2. The bottle opener of claim 1, wherein each of the tabs is rectangular.

3. The bottle opener of claim 1, wherein the piece of equipment is a piece of sports equipment selected from the group of pieces of sports equipment comprising hockey sticks, lacrosse sticks, golf clubs, field hockey sticks, and curling brooms.

4. The bottle opener of claim 1, wherein the piece of equipment is a tool selected from the group of yard tools comprising shovels, rakes, hoes, weeders, shears, hammers and brooms.

5. A bottle opener for a piece of equipment, the bottle opener comprising:
a. a hollow cylinder having an opening at its top end and an enclosed bottom end, wherein the inner dimensions and shape of the cylinder are selected to permit the cylinder to snugly fit into the end of a hollow handle of the piece of sports equipment;
b. a lip projecting outwardly from the periphery of the top end of the cylinder; and
c. first and second opposing tabs projecting into the top end opening from a central position on opposing sides of the opening.

6. The bottle opener of claim 5, wherein each of the tabs is rectangular.

7. The bottle opener of claim 5, wherein the piece of equipment is a piece of sports equipment selected from the group of pieces of sports equipment comprising hockey sticks, lacrosse sticks, golf clubs, field hockey sticks, and curling brooms.

8. The bottle opener of claim 5, wherein the piece of equipment is a tool selected from the group of yard tools comprising shovels, rakes, hoes, weeders, shears, hammers and brooms.

9. A bottle opener for a piece of equipment, the bottle opener comprising:
a. a flat loop having horizontal cross-sectional dimensions less than the horizontal cross-sectional dimensions of the top end of the handle of the piece of sports equipment, the opening in the loop having a length greater than the diameter of a bottle cap;
b. means for pivotal attachment of one side of the flat loop to the top end of the handle of the piece of sports equipment; and
c. a tab projecting into the opening from a central position on the opposing side of the flat loop.

10. The bottle opener of claim 9, wherein the means for pivotal attachment comprises a vertical hinge pin for horizontal rotation.

11. The bottle opener of claim 9, wherein the means for pivotal attachment comprises a hinge for axial rotation about one edge of the loop.

12. The bottle opener of claim 9, further comprising means for retaining the flat loop adjacent the top of the handle of the piece of sports equipment.

13. The bottle opener of claim 12, wherein the means for retaining the flat loop adjacent the top of the handle is a magnet disposed within the top end of the handle.

14. The bottle opener of claim 12, wherein the means for retaining the flat loop adjacent the top of the handle is a resilient spring which in an unstressed state returns the flat loop to a closed position atop the handle.

15. The bottle opener of claim 12, wherein the means for retaining the flat loop adjacent the top of the handle is a resistant hinge pin which retains the flat loop in the rotational position to which it is pivoted.

16. The bottle opener of claim 9, wherein the piece of equipment is a piece of sports equipment selected from the group of pieces of sports equipment comprising hockey sticks, lacrosse sticks, golf clubs, field hockey sticks, and curling brooms.

17. The bottle opener of claim 9, wherein the piece of equipment is a tool selected from the group of yard tools comprising shovels, rakes, hoes, weeders, shears, hammers and brooms.
